(19) United States
(12) Patent Application Publication
(10) Pub. No.: US 2017/0127101 A1
(43) Pub. Date: May 4, 2017

(54) REDUCING STARTUP LATENCY IN A VIDEO PLACE-SHIFTING SYSTEM

(71) Applicant: ECHOSTAR TECHNOLOGIES L.L.C., Englewood, CO (US)

(72) Inventors: Mohammed Rasool, Bangalore (IN); Yatish J. Naik Raikar, Bangalore (IN); Kiran Chittella, Bangalore (IN); Laxminarayana M. Dalimba, Bangalore (IN); Varunkumar B. Tripathi, Bangalore (IN)

(21) Appl. No.: 14/930,343

(22) Filed: Nov. 2, 2015

(51) Int. Cl. H04N 21/2343; H04N 21/2662; G11B 27/10; H04N 21/442; H04N 21/845; H04N 21/61; H04N 21/44

(52) U.S. Cl. CPC H04N 21/234309; H04N 21/6125; H04N 21/2662; H04N 21/44004; H04N 21/44209; H04N 21/8456; G11B 27/10

(57) ABSTRACT

A method of processing and delivering video content is disclosed. An embodiment of the method feeds an original stream of video data to a transcoding engine of a video place-shifting device. The engine receives the original stream at a data rate that exceeds a real time presentation data rate of the original stream. The engine transcodes the received original video data into a streaming video format compatible with presentation capabilities of a remote user device. The controlling causes the engine to transcode the received original video data at a transcoding data rate that exceeds the real time presentation data rate of the original stream. The transcoded video data is provided to a network linked to the remote user device. The video place-shifting device provides the transcoded video data to the network at a network transfer data rate that exceeds the real time presentation data rate of the original stream.

### TECHNICAL FIELD

Embodiments of the subject matter described herein relate generally to video delivery systems and related operating methodologies. More particularly, embodiments of the subject matter relate to techniques and technologies related to the place-shifting of video content from a server system to a remote presentation device.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Video place-shifting techniques enable a subscriber of a video service to view programming content on a device that is remotely located, relative to the incoming source of video. Video place-shifting can be performed by a devoted piece of hardware (i.e., equipment that is designed specifically as a place-shifting device), or by a host system, device, or piece of equipment having the desired place-shifting functionality (such as an STB or a smart television set having native place-shifting functionality integrated therein). A place-shifting device receives a source video stream, transcodes the stream for transport over a network (such as the Internet), and sends the transcoded video data to the user's remote device. Place-shifted video can be presented on a variety of user devices, such as a laptop computer, a mobile phone, a tablet computer, or the like.

Playback of place-shifted video content begins a brief time after the user initiates playback, changes place-shifted video channels, or resumes playback of a place-shifted program that has been paused. The amount of delay can be influenced by various factors, such as the available network bandwidth, the transcoding resources available at the place-shifting device, the size and current capacity of buffers at the place-shifting device and/or the remote presentation device, and the like.

The time delay associated with the startup of place-shifted video content can be lengthy and bothersome under most operating conditions. The time delay is caused by the processing time required to transcode the source video content, the network transmission time, and client device buffering and processing time. Consequently, the time delay associated with the startup of place-shifted video content can be influenced by the available bandwidth of the communication network, the processing speed and resources available to the place-shifting device, the processing speed and resources available to the client device, and the like. Accordingly, it is desirable to have a techniques and technologies that can reduce the startup latency of place-shifted video content. Furthermore, other desirable features and characteristics will become apparent from the subsequent detailed description and the appended claims, taken in conjunction with the accompanying drawings and the foregoing technical field and background.

### BRIEF SUMMARY

A method of processing and delivering video content in accordance with an exemplary embodiment is disclosed herein. The feeds an original stream of video data to a transcoding engine of a video place-shifting device. The transcoding engine receives the original stream of video data at a data rate that exceeds a real time presentation data rate of the original stream of video data. The method continues by controlling the transcoding engine to transcode the received original stream of video data into a streaming video format compatible with presentation capabilities of a remote user device. The controlling causes the transcoding engine to transcode the received original stream of video data at a transcoding data rate that exceeds the real time presentation data rate of the original stream of video data, resulting in transcoded video data. The transcoded video data is provided to a communication network linked to the remote user device. The video place-shifting device provides the transcoded video data to the communication network at a network transfer data rate that exceeds the real time presentation data rate of the original stream of video data.

An exemplary embodiment of a video processing system is also presented herein. The system includes an input interface that operates to receive an original stream of video data, a transcoding engine that transcodes video data from a first format to a second format, a processing architecture having at least one processor, and a non-transitory computer readable medium operatively associated with the processing architecture. The computer readable medium stores executable instructions that, when executed by the processing architecture, cause the processing architecture to perform a method that involves feeding the original stream of video data to the transcoding engine at a data rate that exceeds a real time presentation data rate of the original stream of video data. The method continues by controlling the transcoding engine to transcode the received original stream of video data into a streaming video format compatible with presentation capabilities of a remote user device. The controlling causes the transcoding engine to transcode the received original stream of video data at a transcoding data rate that exceeds the real time presentation data rate of the original stream of video data, resulting in transcoded video data. The transcoded video data is provided to a communication network linked to the remote user device. The video place-shifting device provides the transcoded video data to the communication network at a network transfer data rate that exceeds the real time presentation data rate of the original stream of video data.

A method of processing and delivering video content is also provided for an exemplary embodiment of a video processing and delivery system having a video place-shifting device and a remote user device communicatively coupled to the video place-shifting device using a communication network. The method involves processing a request to begin or resume place-shifting of recorded video content that is stored in a first video format having a native presentation bitrate associated therewith. In response to the processing of the request, the method feeds an initial segment of an original stream of video data to a transcoding engine of the video place-shifting device. The original stream of video data corresponds to the recorded video content, and the transcoding engine receives the initial segment at an accelerated data rate that exceeds a real time presentation data rate of the original stream of video data. The method continues by transcoding, with the transcoding engine, the initial segment from the first video format into a second video format compatible with presentation capabilities of the remote user device. The transcoding is performed at a transcoding data rate that exceeds the real time presentation data rate of the original stream of video data, and the transcoding is performed to decrease the native presentation bitrate of the initial segment, resulting in a transcoded stream of video data. The transcoded stream of video data is delivered to the remote user device via the communication network. The video place-shifting device provides the transcoded stream of video data to the communication network at a network transfer data rate that exceeds the real time presentation data rate of the original stream of video data.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a video place-shifting system;

FIG. 2 is a diagram that illustrates a video processing scheme that reduces startup latency of place-shifted video content; and

FIG. 3 is a flow chart that illustrates an exemplary embodiment of a video processing method.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content (e.g., video programs, movies, recorded television shows, etc.), the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based content delivery system, or the like. The disclosed subject matter relates to a system and related methodology that reduces the startup latency associated with the delivery of a stream of video data to a presentation device. In certain embodiments, the disclosed methodology reduces the startup latency of place-shifted video content that originates at a server system that transcodes the original video data and communicates the transcoded video data to the presentation device via a data communication network such as the Internet.

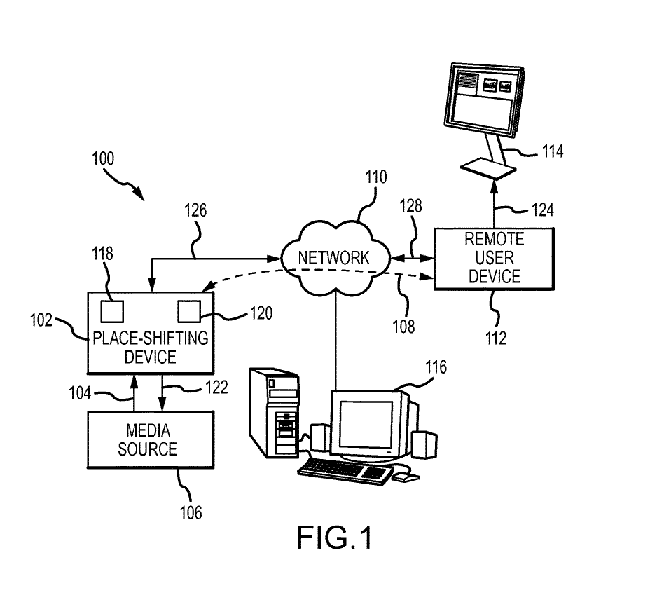

FIG. 1 is a block diagram that illustrates an exemplary embodiment of a video place-shifting system 100, which is suitably configured to provide media content to a remote user device. The system 100 can be utilized to carry out place-shifting and other processing of video content. Certain embodiments of the system 100 include a digital media processing device (e.g., a digital media place-shifting device 102) that receives a video stream 104 from a media source 106, transcodes the received video stream 104 into a streaming format, and then transmits the transcoded video stream 108 to a remotely-located digital media player or other presentation device over a data communication network 110. The presentation device is referred to herein as a remote user device 112, which is communicatively linked to the place-shifting device by way of the network 110. The remote user device 112 receives the transcoded video stream 108, decodes the stream, and presents the decoded content to a viewer on a television set, the native display element of the remote user device 112, or other display 114. Although not depicted in FIG. 1, the remote user device 112 includes or cooperates with at least one speaker, audio transducer, or other sound-generating element that supports the presentation of the audio portion of media streams. In various embodiments, a centralized mediation server device 116 may also be provided to communicate with the place-shifting device 102 and/or the remote user device 112 via the network 110 to assist these devices in locating each other, maintaining security, providing or receiving content or information, and/or any other features as desired.

The place-shifting device 102 is any component, hardware, software logic, etc., or any combination thereof, which is capable of processing video data for purposes transmitting a packetized stream of encoded media content over the network 110. For example, the place-shifting device 102 may be a physically distinct component that is operatively coupled to a video services receiver (a set-top box) that serves as the media source 106. As another example, the place-shifting device 102 may be integrated with a video services receiver. In various embodiments, the place-shifting device 102 incorporates suitable encoder and/or transcoder logic in the form of a transcoding engine 118. Accordingly, the place-shifting device 102 can be implemented as (or is integrated with) an electronic processor-based component. Regardless of its form factor and hardware platform, the place-shifting device 102 is suitably configured to support the desired features and functions using the appropriate hardware, software, firmware, etc. For example, the place-shifting device 102 may include, without limitation: an input module or interface to receive the video stream 104 from the media source 106; a network communication module to interface with the data communication network 110; device-specific hardware, software, firmware, and/or applications; a processing architecture having at least one processor device; and at least one memory element having a suitable amount of storage capacity. The memory element can include any type of computer readable medium that is operatively associated with the processing architecture, wherein the medium contains executable instructions that, when executed by the processing architecture, cause the processing architecture and the place-shifting device 102 to perform the various methods and techniques described herein.

The place-shifting device 102 can include a suitably designed and configured input interface that operates to receive the original stream of video data from the media source 106. In turn, the transcoding engine 118 receives the original stream of video data (the video stream 104) and transcodes the video data from its original format to a packetized format that can be transmitted over the network 110. The original video stream 104 may be received in any format, and may be received from any internal or external media source 106 such as any sort of broadcast source, a cable or satellite television programming source, a “video-on-demand” or similar source, a digital video disk (DVD) or other removable media, a video camera, and/or the like. In accordance with the operating scenarios described herein, a video stream received and processed by the place-shifting device 102 is a stream of recorded video data, which may be provided by the media source 106, by a digital video recorder module, by a video services receiver coupled to the place-shifting device 102, or by any suitably configured device or system that includes or cooperates with a compatible data storage element that maintains the recorded video data. In this context, the recorded video stream could be realized as a locally recorded file, or it could be realized as an on-demand video stream. In some operating scenarios, a video stream received and processed by the place-shifting device 102 is a non-recorded broadcast video stream, which is currently being delivered by a video services system. The place-shifting device 102 transcodes the original video stream 104 to create the transcoded video data of the video stream 108 in any manner. In various embodiments, the place-shifting device 102 contains a transmit buffer 120 that temporarily stores encoded data prior to transmission on the network 110.

In practice, an embodiment of the place-shifting device 102 may be implemented using any of the various SLINGBOX products available from Sling Media of Foster City, Calif., although other products could be used in other embodiments. Certain embodiments of the place-shifting device 102 are generally capable of receiving the video stream 104 from an external media source 106 such as any sort of digital video recorder (DVR), set top box (STB), cable or satellite programming source, DVD player, and/or the like. In such embodiments, the place-shifting device 102 may additionally provide commands 122 to the media source 106 to produce the desired video stream 104. Such commands 122 may be provided over any sort of wired or wireless interface, such as an infrared or other wireless transmitter that emulates remote control commands receivable by the media source 106. Other embodiments, however, may modify or omit this feature entirely.

In other embodiments, the functionality of the place-shifting device 102 may be integrated with any sort of content-receiving or other capabilities typically affiliated with the media source 106. Accordingly, the place-shifting device 102 may be a hybrid STB or other receiver, for example, that also provides transcoding and place-shifting features. Such a device may receive satellite, cable, broadcast and/or other signals that encode television programming or other content received from an antenna, modem, server and/or other source. A receiver of the place-shifting device 102 may further demodulate or otherwise decode the received signals to extract programming that can be locally viewed and/or place-shifted to the remote user device 112 as appropriate. In this regard, the place-shifting device 102 may also include a content database stored on a hard disk drive, memory, or other storage medium or data storage element to support a personal or digital video recorder (DVR) feature or other content library as appropriate. Hence, in some embodiments, the media source 106 and the place-shifting device 102 may be physically and/or logically contained within a common component, housing or chassis.

In still other embodiments, the place-shifting device 102 includes or is implemented as a software program, applet, or the like executing on a conventional computing system (e.g., a personal computer). In such embodiments, the place-shifting device 102 may encode, for example, some or all of a screen display typically provided to a user of the computing system for place-shifting to a remote location. One device capable of providing such functionality is the SlingProjector product available from Sling Media of Foster City, Calif., which executes on a conventional personal computer, although other products could be used as well.

The remote user device 112 is any device, component, module, hardware, software, etc., or any combination thereof, which is capable of receiving the transcoded video stream 108 from the place-shifting device 102. In various embodiments, the remote user device 112 is personal computer (e.g., a laptop or similarly portable computer, although desktop-type computers could also be used), a mobile phone, a personal digital assistant, a personal media player, or the like. In many embodiments, the remote user device 112 is a general purpose computing device that includes a media player application in software or firmware that is capable of securely connecting to the place-shifting device 102, and is capable of receiving and presenting media content to the user of the device as appropriate. In other embodiments, however, the remote user device 112 is a standalone or other separate hardware device capable of receiving the encoded video stream 108 via any portion of the network 110 and decoding the encoded video stream 108 to provide an output signal 124 that is presented on the display 114. One example of a standalone remote user device 112 is the SLINGCATCHER product available from Sling Media of Foster City, Calif., although other products could be equivalently used.

The place-shifting device 102 and/or the remote user device 112 are therefore able to communicate in any manner with the network 110 (e.g., using any sort of data communication links 126 and/or 128, respectively). Such data communication may take place over a wide area link that includes the Internet and/or a telephone network, for example; in other embodiments, communications between the place-shifting device 102 and the remote user device 112 may take place over one or more wired or wireless local area links that are conceptually incorporated within the network 110. In various equivalent embodiments, the place-shifting device 102 and the remote user device 112 may be directly connected via any sort of cable (e.g., an Ethernet cable or the like) with little or no other network functionality provided.

Many different place-shifting scenarios could be formulated based upon available computing and communications resources, consumer demand and/or any other factors. In various embodiments, consumers may wish to place-shift content within a home, office or other structure, such as from the place-shifting device 102 to a desktop or portable computer located in another room. In such embodiments, the content stream will typically be provided over a wired or wireless local area network operating within the structure. In other embodiments, consumers may wish to place-shift content over a broadband or similar network connection from a primary location to a computer or other remote user device 112 located in a second home, office, hotel or other remote location. In still other embodiments, consumers may wish to place-shift content to a mobile phone, personal digital assistant, media player, video game player, automotive or other vehicle media player, and/or other device via a mobile link (e.g., a GSM/EDGE or CDMA/EVDO connection, any sort of 3G or subsequent telephone link, an IEEE 802.11 “Wi-Fi” link, and/or the like). Several examples of place-shifting applications available for various platforms are provided by Sling Media of Foster City, Calif., although the concepts described herein could be used in conjunction with products and services available from any source.

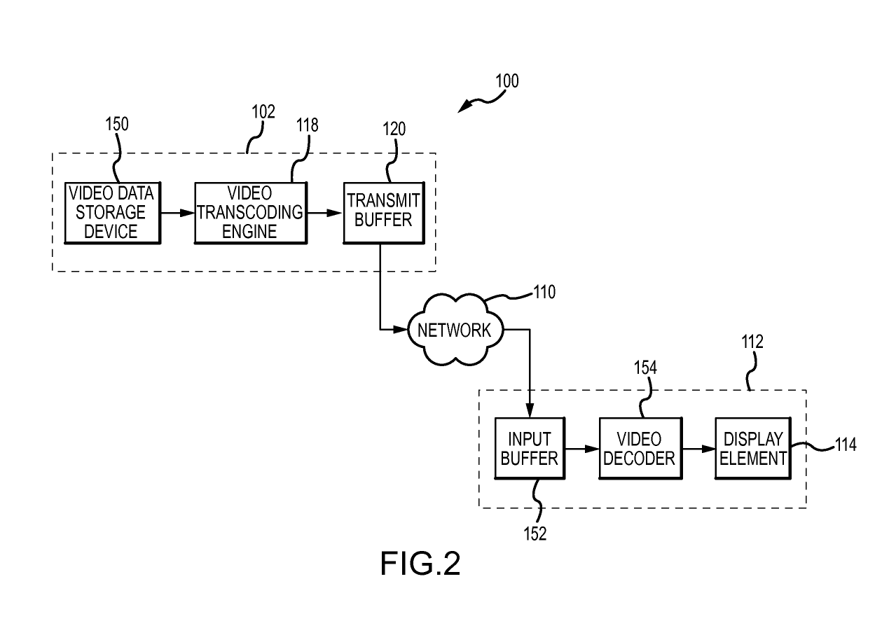

FIG. 2 is a diagram that illustrates a video processing scheme that reduces startup latency of place-shifted video content. FIG. 2 depicts the system 100 in an alternate and somewhat simplified manner. In this regard, FIG. 2 shows the place-shifting device 102, the remote user device 112, and the communication network 110 that links the place-shifting device 102 and the remote user device 112. As described above with reference to FIG. 1, the place-shifting device 102 includes a transcoding engine 118 and a transmit buffer. The embodiment shown in FIG. 2 includes a storage device 150 (such as a hard drive or a solid state drive) that stores recorded video data that corresponds to one or more recorded streams of video data. In practice, the storage device 150 stores video programs in a first format (also referred to herein as the original format), and any number of different video programs can be recorded and stored in the storage device 150, subject to the storage capacity and other hardware limitations.

Place-shifting of recorded video content can be carried out by the place-shifting device in the following manner. In response to a request for recorded video content, the transcoding engine 118 obtains a corresponding stream of video data from the storage device 150, either directly or indirectly as appropriate to the particular embodiment. The transcoding engine 118 transcodes the original stream of video data into the desired format for delivery to the remote user device 112, and provides the transcoded video data to the transmit buffer 120. The transmit buffer 120 receives and buffers the transcoded video data such that the transcoded video data can be communicated to the network 110 as needed. In certain embodiments, the transcoded video data is buffered at the place-shifting device 102 so that the remote user device 112 can request or “pull” the transcoded video data at the appropriate time.

As explained above with reference to FIG. 1, the remote user device 112 includes or cooperates with a display 114 that presents the place-shifted video content to the user. The remote user device 112 can include an input buffer 152 that receives the incoming stream of transcoded video data. The input buffer 152 can be sized to suit the needs of the particular application, and to enable the remote end user device 112 to present the video content in a seamless manner with little to no stuttering or other playback artifacts. In some embodiments, the remote user device 112 pulls transcoded video data into its input buffer 152 on demand or as needed. In alternative embodiments, the place-shifting device 102 pushes the transcoded video data to the remote user device 112 when it is determined that the input buffer 152 can accommodate more data. The transcoded video data received by the remote end user device 112 is decoded by a suitably configured video decoder 154. The video decoder 154 decodes the video data such that the remote user device 112 can display the video information and play the accompanying audio information (if any).

Startup delay in the system 100 can be caused by any number of factors. For example, there can be some delay associated with the delivery of the original video stream to the transcoding engine 118. In addition, the transcoding process performed by the transcoding engine can be a source of delay, especially if the original video data is transcoded in real presentation time or slower than real presentation time. Moreover, transferring the transcoded video data across the network 110 can introduce delay, more or less depending on the available network bandwidth and operating conditions. The techniques and methodologies presented here can be utilized to reduce startup latencies by dynamically throttling the processing and/or transmission of the transcoded video data. The solution presented herein addresses startup latency where the video content must be transcoded and streamed on the fly (e.g., at the request of the end user) over a network such as the Internet. The solution presented herein reduces the startup delay experienced by the end user by transcoding the original video data in an accelerated manner (i.e., in “hyper” real time or “super” real time, relative to the nominal and regular playback or presentation timing of the video content).

Accelerated transcoding of the video data can be performed for a limited time at or near the beginning of the requested video content. This allows the end user to begin viewing the place-shifted video content quickly and with less delay relative to existing delivery schemes. Eventually, the place-shifting device 102 can transition back to a “normal” transcoding process that supports real time streaming of the transcoded video data. The place-shifting device 102 can dynamically react and respond to current network bandwidth status and/or the operating status of the remote user device 112, for purposes of determining when to transition from the accelerated processing scheme to the normal processing scheme.

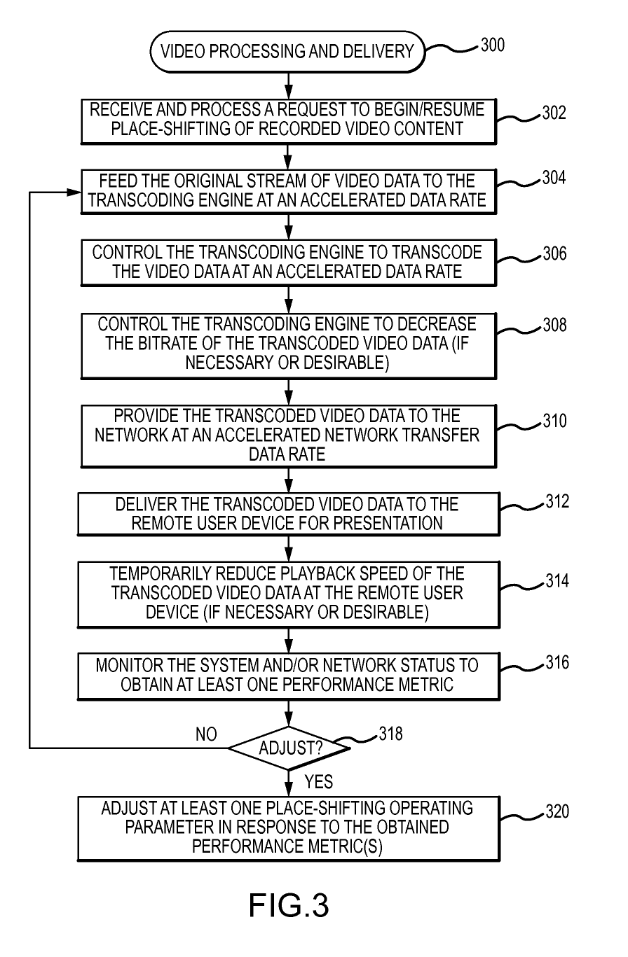

FIG. 3 is a flow chart that illustrates an exemplary embodiment of a video processing method 300. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., a video content source or server, a video services receiver, a place-shifting device, a presentation device, etc. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The following description of the process 300 assumes that a network communication link (session) has already been established between the place-shifting device and a compatible remote presentation device (i.e., the end user device that will play the place-shifted video content). Thus, the process 300 begins by receiving and processing a request, instruction, or command to begin or resume the place-shifting of video content (task 302). The request can be initiated at the remote user device in response to the user selecting new video content for playback, unpausing the playback of previously requested place-shifted video content, changing “channels” of available place-shifted video content, or the like. For reasons that are explained in more detail below, the process 300 is particularly suited for the handling of recorded video content that is readily available at the place-shifting device. Accordingly, the example described here assumes that the requested video content is recorded content that is stored at the place-shifting device or is otherwise available for direct access by the place-shifting device. For example, the requested video content can be stored in a hard drive or a solid state drive that is resident at the place-shifting device. The recorded video content is stored in an original video format having a native presentation bitrate associated therewith. For example, the native bitrate of video content is typically within the range of about 2.0 Mbps for Standard Definition, about 8.0 Mbps for High Definition, about 20 Mbps for ATSC/OTA, and about 14 Mbps for PPV. Note that these bitrates are the input content bitrates, i.e., the bitrates at which the content is broadcast by the network providers. As used herein, the “native presentation bitrate” is the normal and regular bitrate of video data, which corresponds to the intended real time presentation resolution and playback speed.

The place-shifting device processes the request as needed to identify or otherwise locate the recorded video data that corresponds to the requested video content, and to initiate the video transcoding procedure. To this end, the process 300 continues by feeding a stream of video data to the transcoding engine of the place-shifting device (task 304). The stream that is fed to the transcoding engine is referred to herein as the “original stream of video data” to distinguish it from any transcoded or otherwise manipulated version of the recorded video data. For newly requested video content, task 304 feeds the initial (leading) segment of the original stream of video data, such that the beginning of the requested video content can be transcoded. If, however, the requested video content represents un-paused content or video content that is in progress, then task 304 begins by feeding the next or current segment (as appropriate) of the original stream of video data.

The place-shifting device is configured and controlled such that the transcoding engine receives the original stream of video data from the data storage element at a data rate that exceeds the real time presentation data rate of the original stream of video data. As used herein, the “real time presentation data rate” is the data rate of video content that corresponds to the usual, regular, and nominal playback speed. In other words, if streaming video content is presented at the regular playback speed, the corresponding real time streaming data rate is the real time presentation data rate. In practice, the transcoding engine is fed the original stream of video data at an accelerated data rate that may be limited by the read speed and specifications of the data storage element, the processing power and speed of the transcoding engine, and/or other factors (available network bandwidth, the capabilities and configuration of the client device, the status of the transmit buffer of the place-shifting device, the status of the input buffer of the client device, or the like). In certain embodiments, task 304 feeds the transcoding engine at two times the real time presentation data rate, although the actual data rate may vary from one embodiment to another, and may be dynamically regulated if so desired. Consequently, the transcoding engine receives two seconds worth of video data (i.e., the amount of data corresponding to two seconds of video playback) in only one second. For the example described here, task 304 accesses recorded video data (that represents the requested video content as conveyed by the original stream of video data) from a data storage element of the place-shifting device. The availability of recorded video content, which can be quickly read from the storage device, enables task 304 to feed the transcoding engine at the accelerated data rate. In contrast, the transcoding of broadcast video content in real time is temporally limited by the available of the real time video stream.

The process 300 controls and operates the transcoding engine to transcode the received original stream of video data into a streaming video format that is compatible with the presentation capabilities and specifications of the requesting remote user device (task 306). For at least the initial segment or portion of the original stream of video data, the transcoding engine transcodes the video data at a transcoding data rate that exceeds the real time presentation data rate of the original stream of video data, resulting in transcoded video data that has been processed and transcoded in an accelerated manner, relative to the actual real time playback rate of the video content. Thus, in contrast to conventional approaches that may transcode the source video data in real presentation time (e.g., ten seconds worth of video content, as played back at normal speed, is transcoded in ten seconds; six seconds worth of video content, as played back at real time speed, is transcoded in six seconds; etc.), the process 300 is capable of accelerated transcoding at the beginning of the requested place-shifted video content, such that the amount of transcoding time needed to transcode T seconds worth of video content (presented at the real time and full playback speed) is less than T seconds.

In practice, the “hyper” transcoding speed of the transcoding engine can be set at a fixed value, or it can be dynamically adjustable in certain embodiments. For example, the maximum transcoding speed of the transcoding engine may be limited by the processing power, design, and configuration of the transcoding engine. If the transcoding speed is dynamically adjustable, then various factors can influence the transcoding speed. These factors may include, without limitation: the available network bandwidth, the capabilities and configuration of the client device, the status of the transmit buffer of the place-shifting device, the status of the input buffer of the client device, control commands issued by the client device, or the like. In certain embodiments, task 306 causes the stream of video data to be transcoded at two times the real time presentation data rate. Accordingly, for this example, the transcoding engine processes and transcodes two seconds worth of video data (i.e., the amount of data corresponding to two seconds of video playback) in only one second.

In certain situations, it may be desirable to regulate the bitrate of the transcoded video data, especially for the initial segment or portion of the place-shifted video content. For example, if a lower video bitrate will result in quicker transcoding and delivery of the transcoded video data, then the process 300 can control the transcoding engine to decrease the native presentation bitrate of the transcoded video data (task 308). Although task 308 may be optional, temporarily decreasing the bitrate of the transcoded video data may be beneficial to accommodate expedited transfer of at least the initial segment of the transcoded video stream over the communication network. Although reducing the bitrate of the video data results in a degradation of the video quality, most users can tolerate an amount of degradation before actually perceiving any changes to the quality. Moreover, decreasing the bitrate of the transcoded video data need not be maintained for more than several seconds. Indeed, the bitrate can be increased for the remainder of the transcoded video data after the initial segment/portion (with decreased bitrate) has been transferred over the communication network.

The place-shifting device provides the transcoded video data to the communication network that is already linked to the remote user device, for purposes of delivering the transcoded stream of video data to the user device (task 310). The place-shifting device provides the transcoded video data to the network at an accelerated network transfer data rate that exceeds the real time presentation data rate of the original stream of video data. As used herein, the “network transfer data rate” refers to the data rate at which the place-shifting device outputs/transfers the transcoded video data. The network transfer data rate utilized at task 310 is accelerated in that it is higher than the real time and usual streaming video data rate of the video content.

In practice, the accelerated network transfer speed can be set at a fixed value, or it can be dynamically adjustable in certain embodiments. For example, the network transfer data rate may be limited by the processing power, design, and configuration of the place-shifting device and/or by the bandwidth available on the network. If the network transfer data rate is dynamically adjustable, then various factors can influence the transfer data rate. These factors may include, without limitation: the available network bandwidth, the capabilities and configuration of the client device, the status of the transmit buffer of the place-shifting device, the status of the input buffer of the client device, control commands issued by the client device, or the like. In certain embodiments, at least the initial segment or portion of the transcoded stream of video data is transferred over the network at two times the normal transfer data rate. This enables the remote user device to receive and begin playback of at least the initial segment of the place-shifted video content in an expedited manner.

The transcoded stream of video data is delivered to the remote user device for presentation to the user (task 312). As explained with reference to FIG. 2, the user device can buffer the received video data as needed to facilitate decoding and rendering in an efficient and accurate manner. In certain situations, it may be desirable to temporarily reduce the playback speed of the transcoded video data at the remote user device (task 314). A slight reduction in the playback speed can enable the user device to receive, buffer, and decode the incoming stream of video data while quickly starting presentation of the video content. The reduced playback speed can be controlled such that the effect is not perceivable or is difficult to detect by the end user. This optional feature accommodates transfer of the transcoded video data at an increased data rate that exceeds the nominal transfer data rate associated with the real time playback speed of the transcoded video data. In other words, the reduction in playback speed allows the user device to perform “catch up” processing while the initial segment of the video content is presented.

The embodiment described here performs the accelerated transcoding and data transfer methodology for a limited period of time at or near the beginning of requested video content. Accordingly, the process 300 can monitor the system status, the network status, and/or other conditions or operating parameters associated with the place-shifting system to obtain at least one performance metric (task 316). The performance metric can be, without limitation: a current network bandwidth metric; a current video presentation metric that is associated with the operation or status of the remote user device; a current status metric or operating parameter of the place-shifting device; a network diagnostic metric; or the like. The process 300 can obtain and analyze some or all of these performance metrics to determine whether or not any adjustments to the place-shifting or transcoding methodology are necessary or desirable (query task 318). If the process 300 determines that no adjustments are needed (the “No” branch of query task 318), then the process 300 returns to task 304 to continue transcoding the recorded video content in the manner described above. If the process 300 determines that one or more adjustments should be made (the “Yes” branch of query task 318), then the process 300 adjusts at least one place-shifting or transcoding operating parameter in response to the obtained performance metric(s) (task 320). The adjusting performed at task 320 may result in an accelerated transcoding scheme, with changed parameters (e.g., the transcoding speed, the bitrate of the transcoded video data, the network transmission speed, the playback speed at the remote user device, or the like). Alternatively, the adjusting performed at task 320 may temporarily halt the accelerated transcoding, terminate the accelerated transcoding, or gradually transition back to the real time real time transcoding scheme.

In certain scenarios, the current available network bandwidth metric influences the bitrate of the transcoded video data, such that the adjusting at task 320 is performed as a function of the obtained network bandwidth metric. For example, if the current available network bandwidth is high enough to accommodate accelerated transcoding at the highest native bitrate, then the transcoding engine can be adjusted to maximize the bitrate of the transcoded video data. As another example, the bitrate of the transcoded video data can be decreased in response to a decrease in the monitored network bandwidth metric, and increased in response to an increase in the monitored network bandwidth metric. As yet another example, the transcoding data rate (i.e., the processing speed of the transcoding engine) can be adjusted based on the obtained network bandwidth metric. In this regard, the transcoding speed can be reduced if network bandwidth is limited, and increased if there is ample network bandwidth available. In certain embodiments, the place-shifting device obtains or calculates the current network bandwidth metric and reduces the transcoding data rate when the network bandwidth metric is less than a threshold value (which indicates that accelerated transcoding is unnecessary, wasteful of resources, unsupported, or the like).

In certain scenarios, the remote user device is monitored (or the user device reports its status to the place-shifting device) to obtain a current video presentation metric that is indicative of the operating status of the user device. The video presentation metric can influence the adjustment of the transcoding data rate (i.e., the transcoding speed of the place-shifting device) if so desired. For example, if the video presentation metric indicates that the input buffer of the user device is near capacity or is otherwise unable to accommodate incoming video data, then the transcoding engine can be slowed down or temporarily halted, or the place-shifting device can be controlled to continue filling its transmit buffer with transcoded video data (while temporarily stopping the transfer of the transcoded video data to the network).

The accelerated transcoding and network transfer scheme described above need not be sustained for the entire stream of recorded video data. Instead, accelerated transcoding and network transfer can be applied to the beginning segment of the requested video content for purposes of reducing the amount of startup latency experienced at the remote user device. Shortly after playback begins at the user device, the accelerated transcoding and network transfer scheme can be throttled back or terminated, resulting in standard real time transcoding of the remainder of the requested video content. The methodology presented herein can reduce the startup latency of a conventional place-shifting streaming video system from about four or five seconds to less than two seconds. In practice, reduction of startup delay by a few seconds makes a distinct and noticeable difference to the end user experience.

As explained above, operation of the place-shifting device can be regulated by any number of mechanisms for purposes of achieving accelerated transcoding and network data transfer, and for purposes of stalling or terminating the accelerated transcoding scheme. One exemplary embodiment takes advantage of the video presentation timestamps that are associated with the original source video data (along with the current system clock) to regulate the transcoding scheme. This timestamp-based scheme assumes that accelerated transcoding is performed at the beginning of the requested video stream.

At the start of the transcoding procedure, a reference clock is initialized. The reference clock runs in real time and is based on the system clock. Also at the start of the transcoding procedure, the program clock reference is initialized. The program clock reference is obtained from the source video data, and the program clock reference is relative to the video presentation timeline. Thus, a 30-minute video program will have a program clock reference value that indicates 30 minutes. If, however, the video program is presented in non real time, then the actual runtime of the program will be more/less than 30 minutes.

After each packet of data is processed, the timestamp data is analyzed to determine the amount of video data that has been transcoded for the given unit of real time. More specifically, if the current value of the program clock reference (which can be calculated by subtracting the initial program clock value from the current program clock value) is less than the current reference clock value (i.e., the real time clock value), then the transcoding engine is controlled to continue with the accelerated transcoding scheme. If, however, the current value of the program clock reference is greater than the current reference clock value, then the system checks whether it is appropriate to continue with the accelerated transcoding.

The exemplary embodiment presented here checks whether the program clock reference value minus the reference clock value is less than a threshold value. If so, then the transcoding engine is controlled to continue with the accelerated transcoding scheme. If not, then the transcoding engine is controlled to stall or hold transcoding for an amount of time. Thereafter, the transcoding engine can be controlled to resume transcoding in real time rather than accelerated time. The threshold value can be empirically determined and fixed as a static value (e.g., three seconds), or it can be dynamically adjusted to respond to current operating conditions. As yet another option, the threshold value can be negotiated by the place-shifting device and the remote user device during a handshaking procedure at the beginning of the session, or it can be selected by the user device and provided to the place-shifting device at the beginning of the session. The threshold is a parameter that indicates the “capacity” of the system to handle additional video data that has been transcoded in an accelerated manner.

In accordance with an alternative embodiment, the transcoding speed of the transcoding engine can be directly controlled in an appropriate manner. For such an embodiment, the transcoding engine can be controlled to perform accelerated transcoding at the beginning of each video stream for a predetermined period of time (such as a few seconds). Thereafter, the transcoding engine is controlled to automatically transition to real time transcoding and network transfer.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of processing and delivering video content, the method comprising:
feeding an original stream of video data to a transcoding engine of a video place-shifting device, wherein the transcoding engine receives the original stream of video data at a data rate that exceeds a real time presentation data rate of the original stream of video data;
controlling the transcoding engine to transcode the received original stream of video data into a streaming video format compatible with presentation capabilities of a remote user device, wherein the controlling causes the transcoding engine to transcode the received original stream of video data at a transcoding data rate that exceeds the real time presentation data rate of the original stream of video data, resulting in transcoded video data; and
providing the transcoded video data to a communication network linked to the remote user device, wherein the video place-shifting device provides the transcoded video data to the communication network at a network transfer data rate that exceeds the real time presentation data rate of the original stream of video data.

2. The method of claim 1, wherein the feeding step comprises accessing recorded video data from a data storage element of the video place-shifting device, the recorded video data corresponding to the original stream of video data.

3. The method of claim 1, further comprising:
decreasing bitrate for an initial segment of the transcoded video data to accommodate expedited transfer of the initial segment over the communication network; and
increasing bitrate for a remainder of the transcoded video data after the initial segment has been transferred over the communication network.

4. The method of claim 1, further comprising:
monitoring the communication network to obtain a current network bandwidth metric; and
adjusting bitrate of the transcoded video data as a function of the obtained current network bandwidth metric.

5. The method of claim 4, wherein the adjusting step comprises:
decreasing the bitrate of the transcoded video data in response to a decrease in the obtained current network bandwidth metric; and
increasing the bitrate of the transcoded video data in response to an increase in the obtained current network bandwidth metric.

6. The method of claim 1, further comprising:
temporarily reducing playback speed of the transcoded video data at the remote user device to accommodate buffering of transcoded video data received by the remote user device at an increased transfer data rate that exceeds a nominal transfer data rate associated with real time playback speed of the transcoded video data.

7. The method of claim 1, further comprising:
monitoring the communication network to obtain a current network bandwidth metric; and
adjusting the transcoding data rate based on the obtained current network bandwidth metric.

8. The method of claim 7, wherein the adjusting step reduces the transcoding data rate when the obtained current network bandwidth metric is less than a threshold value.

9. The method of claim 1, further comprising:
monitoring the remote user device to obtain a current video presentation metric; and
adjusting the transcoding data rate based on the obtained current video presentation metric.

10. A video processing system comprising:
an input interface that operates to receive an original stream of video data;
a transcoding engine that transcodes video data from a first format to a second format;
a processing architecture having at least one processor; and
a non-transitory computer readable medium operatively associated with the processing architecture, the computer readable medium comprising executable instructions that, when executed by the processing architecture, cause the processing architecture to perform a method comprising:
feeding the original stream of video data to the transcoding engine at a data rate that exceeds a real time presentation data rate of the original stream of video data;
controlling the transcoding engine to transcode the received original stream of video data into a streaming video format compatible with presentation capabilities of a remote user device, wherein the controlling causes the transcoding engine to transcode the received original stream of video data at a transcoding data rate that exceeds the real time presentation data rate of the original stream of video data, resulting in transcoded video data; and
providing the transcoded video data to a communication network linked to the remote user device, wherein the video place-shifting device provides the transcoded video data to the communication network at a network transfer data rate that exceeds the real time presentation data rate of the original stream of video data.

11. The video processing system of claim 10, wherein the executable instructions cause the processing architecture to:
decrease bitrate for an initial segment of the transcoded video data to accommodate expedited transfer of the initial segment over the communication network; and
increase bitrate for a remainder of the transcoded video data after the initial segment has been transferred over the communication network.

12. The video processing system of claim 10, wherein the executable instructions cause the processing architecture to:
monitor the communication network to obtain a current network bandwidth metric; and
adjust bitrate of the transcoded video data as a function of the obtained current network bandwidth metric.

13. The video processing system of claim 10, wherein the executable instructions cause the processing architecture to:
temporarily reduce playback speed of the transcoded video data at the remote user device to accommodate transfer of the transcoded video data at an increased transfer data rate that exceeds a nominal transfer data rate associated with real time playback speed of the transcoded video data.

14. The video processing system of claim 10, wherein the executable instructions cause the processing architecture to:
monitor the communication network to obtain a current network bandwidth metric; and
adjust the transcoding data rate based on the obtained current network bandwidth metric.

15. The video processing system of claim 10, wherein the executable instructions cause the processing architecture to:
monitor the remote user device to obtain a current video presentation metric; and
adjust the transcoding data rate based on the obtained current video presentation metric.

16. In a video processing and delivery system comprising a video place-shifting device and a remote user device communicatively coupled to the video place-shifting device using a communication network, a method of processing and delivering video content, the method comprising:
processing a request to begin or resume place-shifting of recorded video content that is stored in a first video format having a native presentation bitrate associated therewith;
in response to the processing of the request, feeding an initial segment of an original stream of video data to a transcoding engine of the video place-shifting device, the original stream of video data corresponding to the recorded video content, the transcoding engine receiving the initial segment at an accelerated data rate that exceeds a real time presentation data rate of the original stream of video data;
transcoding, with the transcoding engine, the initial segment from the first video format into a second video format compatible with presentation capabilities of the remote user device, the transcoding performed at a transcoding data rate that exceeds the real time presentation data rate of the original stream of video data, and the transcoding performed to decrease the native presentation bitrate of the initial segment, resulting in a transcoded stream of video data; and
delivering the transcoded stream of video data to the remote user device via the communication network, wherein the video place-shifting device provides the transcoded stream of video data to the communication network at a network transfer data rate that exceeds the real time presentation data rate of the original stream of video data.

17. The method of claim 16, further comprising:
temporarily reducing playback speed of the transcoded stream of video data at the remote user device to accommodate transfer of the transcoded stream of video data at an increased transfer data rate that exceeds a nominal transfer data rate associated with real time playback speed of the transcoded stream of video data.

18. The method of claim 16, further comprising:
monitoring the communication network to obtain a current network bandwidth metric; and
adjusting the transcoding data rate based on the obtained current network bandwidth metric.

19. The method of claim 18, wherein the adjusting step reduces the transcoding data rate when the obtained current network bandwidth metric is less than a threshold value.

20. The method of claim 16, further comprising:
monitoring the remote user device to obtain a current video presentation metric; and
adjusting the transcoding data rate based on the obtained current video presentation metric.
